(19) United States
(12) Patent Application Publication
(10) Pub. No.: US 2009/0123346 A1
(43) Pub. Date: May 14, 2009

(54) Modular Fluidised Bed Reactor

(76) Inventors: Jean-Xavier Morin, Neuville Aux Bois (FR); Corinne Beal, Voisins Le Bretonneux (FR); Jean-Luc Lascombes, St. Maur Des Fosses (FR)

Correspondence Address: ALSTOM POWER INC.;INTELLECTUAL PROPERTY LAW DEPT., P.O. BOX 500, WINDSOR, CT, 06095, US

(21) Appl. No.: 11/989,740

(22) PCT Filed: Aug. 1, 2005
(86) PCT No.: PCT/FR2005/050639

§ 371 Date: Jan. 30, 2008

(51) Int. Cl. B01J 8/26

(52) U.S. Cl. 422/142

(57) ABSTRACT

The fluidised bed reactor according to the invention comprises a reaction chamber (1, 1a, 1b), coupled by an acceleration sheath (10, 10a, 10b) to a centrifugal separator (2, 2a, 2b) for separating particles from hot gases coming from said reaction chamber (1, 1a, 1b), whereby the assembly comprises the reaction chamber (1, 1a, 1b), the separator (2, 2a, 2b) and a rear cage (3, 3a, 3b).

The present invention relates to circulating fluidised bed reactors for reacting solid gases and producing energy and to boilers.

These reactors comprise a reaction chamber where the solid gas reactions take place, a centrifugal separator with the means for re-circulating the solids to the bottom of the reaction chamber and, typically, a heat exchanger or means of regulating the temperature in the reaction chamber.

To simplify things, only a description of the state-of-the-art circulating fluidised bed boiler will be provided in this application.

The boilers comprise a hearth for burning the fuel, a centrifugal separator with the means to re-circulate the solids to the bottom of the hearth and at least one heat exchanger to regulate the temperature in the reaction chamber.

Controlling the greenhouse gas emissions, such as CO₂ for example, is an unavoidable technical constraint for the energy producing stations using fossil fuels. This control means that new problems have to be overcome at minimum cost and impact, such as capturing the CO₂ in the fumes emitted from the stations or using renewable biomass type energy (non fossil carbon).

Finally, the gradual rarefaction of oil deposits makes it more urgent to implement large-scale recovery technologies assisted by injecting CO₂, which can more than double some of the accessible reserves.

Already known is the conversion of solid fuels containing carbon materials, by way of thermo-chemical combustion to produce combustion fumes containing essentially CO₂ and H₂O without nitrogen ballast, so that these fumes can be used in the assisted recovery of oil or to be able to confine these fumes underground, as proposed in the techniques for reducing greenhouse gas emissions.

With this approach, there is no need to have recourse to a specific air distillation unit to produce the oxygen, which entails a high consumption of electrical energy.

This conversion is carried out by two circulating fluidised bed reactors: an oxidation reactor and a conversion reactor. These are connected together to produce the exchange of solid metallic oxides, which act as oxygen carriers before they are successively reduced and then oxidised in the loop.

This interconnection is a major constraint in the arrangement of the two reactors, the respective size of which differs by a ratio of 1 to 3, or even 1 to 4, owing to the separation of the nitrogen thinner, also referred to as “nitrogen ballast” and to the recycling of CO₂/H₂O/SO₂ in the conversion reactor. Each reactor comprises, in fact, three elements to ensure operation: an actual reactor or reaction chamber, a cyclone or separator linked to a siphon and a rear boiler, also referred to as the rear cage, which has to be combined reciprocally and to which are added the exterior beds on the oxidation reactor and a carbon separator/stripper, also known as a “carbon stripper” in the solids return line from the conversion reactor to the oxidation reactor.

However, it is necessary to have a concept that can be extrapolated for large sizes of 20 to 400 MWe approximately and which minimises the solids connection sheaths between the two reactors.

Finally, one must also underline the constraint produced by the use of solid refractory materials since conventionally, the conversion reactor is fully clad with refractory materials or “refractorised” over its loop (reactor, sheath, cyclone, siphon) whilst the conversion reactor is only coated with refractory materials on its bottom section and on the sheath, cyclone and siphon. These loop elements have sheet metal protection and a multi-layer refractory coating of 400 to 500 mm. This entails high maintenance costs and operating constraints in that start-up and shut-down take longer, in order to accommodate these vast thicknesses with a limited thermal gradient.

Considering the above constraints, it would appear that designing such a boiler with an integral and compact arrangement that can be extrapolated, in order to produce the functions required, would be a formidable problem to overcome.

The applicant of the present application has also perfected application No. PCT WO 2004/036118. This latter application describes, in particular, a basic module comprising a reaction chamber or reactor, a separator and rear cage, where the reaction chamber and separator have straight walls.

Conventionally, the reaction chamber is placed in front of the separator, which in turn is positioned in front of the rear cage. This solution is, in fact, the most logical since the fumes produced by the reaction chamber pass through the separator with the particles returning to the chamber, whilst the remainder of the fumes is processed in the rear cage. The separator is located in the centre between the reaction chamber and rear cage, thereby minimising the connection sheaths between these elements.

The purpose of the present invention is to propose a configuration which is compact, modular and especially adapted to the design of a double boiler with fluidised beds, with interconnections so as to guarantee the exchange of the oxygen-carrying oxides, which are successively reduced before becoming oxidised in the loop in order to capture the CO₂.

The fluidised bed reactor according to the invention comprises a reaction chamber linked to a centrifugal separator by way of an acceleration sheath, for purposes of separating particles from the hot gases coming from said reaction chamber, with the whole assembly comprising the reaction chamber, separator and rear cage, making up the basic module. This is characterised in that it comprises at least two modules, one where the reaction chamber is positioned between the separator and rear cage and the other where the separator is positioned between the reactor and the rear cage. The advantage of this arrangement compared with what is conventionally deployed, is the ability to position the separator of each of these modules alongside the reaction chamber of the other module, which may be advantageous for some configurations where the particles pass from one reaction chamber to the other through the separator, with the rear cage being common to both. The combination of a conventional module with central separator and a module with a central reactor mean that the distance between the separators and reaction chambers is thus reduced, as is also the length of the piping between these different elements. The number of modules to be used is calculated on the basis of the power required.

According to a special arrangement, part of the acceleration sheath is arranged at least in the top section of the reaction chamber. The centrifugal separator has virtually straight, vertical walls. The position of the acceleration sheath for the particles in the reaction chamber means that it is possible to combine or even have one common wall between the said chamber and separator, thereby increasing the overall available volume. The fact that the sheath is incorporated at least in the top section of each reactor, as described in patent WO 2204/036118, means that the solids escaping through the separators are now reduced to a minimum.

According to a particular characteristic, the walls are common. The use of common walls for each reactor, separator and rear cage assembly unit now makes it possible to obtain an aligned and compact arrangement.

According to another arrangement, the rear cage of the two types of module has a common wall. The rear cages are placed side by side and can have common walls with the separator or reactor, depending on configuration. It is therefore possible to retain tubed walls, which are easy to build, and to install sweepers to clean off any dust deposits on the tubes, leaving a sufficiently small space, so as to minimise the risk of solid deposits settling between the adjacent separator, owing to the fact that the fumes no longer need to flow through long connecting pipes.

According to another arrangement, the reactor and separator have a common wall. The reactor can be of a square or rectangular shape.

According to a further arrangement, the reactor and rear cage have a common wall. The exterior bed may be located under the rear cage and be connected to the oxidation reactor it supplies through the corresponding siphon.

According to another arrangement, the separator and rear cage have a common wall.

According to a particular characteristic, the common walls between the reactors and between the separators and rear cages are doubled and comprise stiffening belts in the space between the double walls. For very large boilers, above 200 MWe, it may be necessary—not only on account of thermal expansion of the assembly comprising the reactors, separators and rear cages, but also on account of the excessive size of the belts retaining the internal pressure reactors—to double up on some of the walls.

According to one variant, at least one of the modules comprises an oxidation reactor and the other a conversion reactor. In such cases the circulating fluidised beds of each boiler are connected together to guarantee the exchange of solid, metallic oxides carrying the oxygen, which are successively reduced and oxidised in the loops in order to produce a concentrated current of CO₂, which is deprived of any nitrogen ballast. The reverse arrangement of the oxidation reactor and conversion reactor with their respective separator makes it possible to juxtapose respectively, the separator of the oxidation reactor with the conversion reactor and the separator of the conversion reactor with the oxidation reactor. A siphon is arranged under each separator: a siphon with two outlets under the separator of the conversion reactor, with one outlet providing the direct return to a conversion reactor and the other to supply the oxidation reactor with solids, and a siphon with two or three outlets under the oxidation reactor to guarantee the direct return to the oxidation reactor and to supply the conversion reactor and exterior beds with solids. This arrangement of the reactors allows for the use of particularly short sheaths, thus avoiding the use of long, fluidised sheaths that are slightly inclined and suitable for defluidisation.

According to another particular arrangement of the above variant, the oxidation reactor comprises at least twice as many modules as the conversion reactor. The principle of extrapolating the size is by maintaining a module with the conversion reactor and at the very least, two modules with the oxidation reactor, followed by extrapolating the size of the reactor section until the equivalent of a unit flow rate of 100 MWe is obtained and by adding in the order of up to four aligned modules. The structure of the basic modules of the oxidation reactor, whose top section is a multiple of that of the conversion reactor, a multiple three or four, results in a section for each separator equal to that of each reactor. Hence, the oxidation reactor, which is bigger, is all of one piece over its bottom section, whilst the top part is segmented by tubed division walls, where the tubes form an integral part with the inlet or acceleration sheaths of the separators and thus comprises the corresponding section of the basic module.

According to a particular arrangement of the above variant, the conversion reactor is located between the separator and rear cage.

According to another variant, at least one of the modules comprises a CO₂ absorption reactor with said CO₂ contained in the fumes following carbonation of CaO and the other comprises a cracking reactor of the CaCO₃ carbonates. In the latter case, the CaO lime undergoes cycles of carbonation and decarbonation. The calcium oxide is successively carbonated by the absorption of CO₂ and decarbonated by cracking.

This highly integral design allows for the use of:
interior beds
top division walls, in addition to the cyclone inlet or acceleration sheaths, which facilitate the separation of solids and heat exchange inside the oxidation reactor
common cooling walls that combine the water vapour emulsion with the slightly overheated steam
forced circulation or otherwise for the super-critical steam cycles.

On the other hand this concept reduces the weight of the parts under pressure thanks to the common walls and reduction of the thickness of the refractory coating of approx. 25 to 50 mm along the periphery of the tube. The low thermal flow present in the conversion and oxidation reactors allows the water vapour emulsion, for example, to flow at a low mass flow rate, whilst the walls of the separators have low-temperature overheated steam passing along them.

The invention will be better understood when reading the following description, which is provided purely as an example and which refers to the enclosed drawings, where:

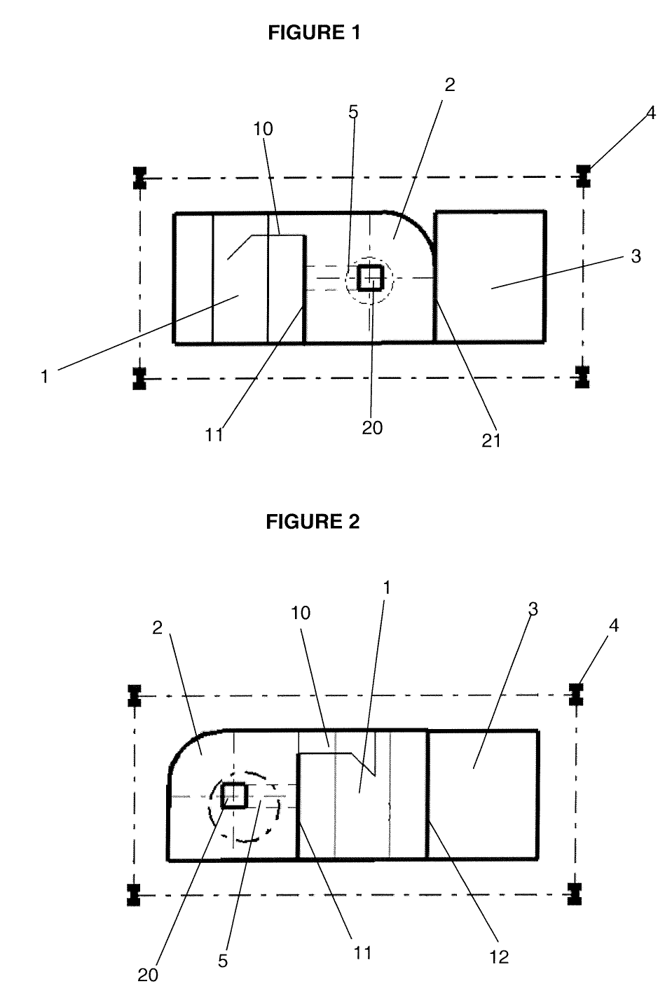

FIG. 1 is a top view of a module according to an initial variant

FIG. 2 is a top view of a module according to a second variant

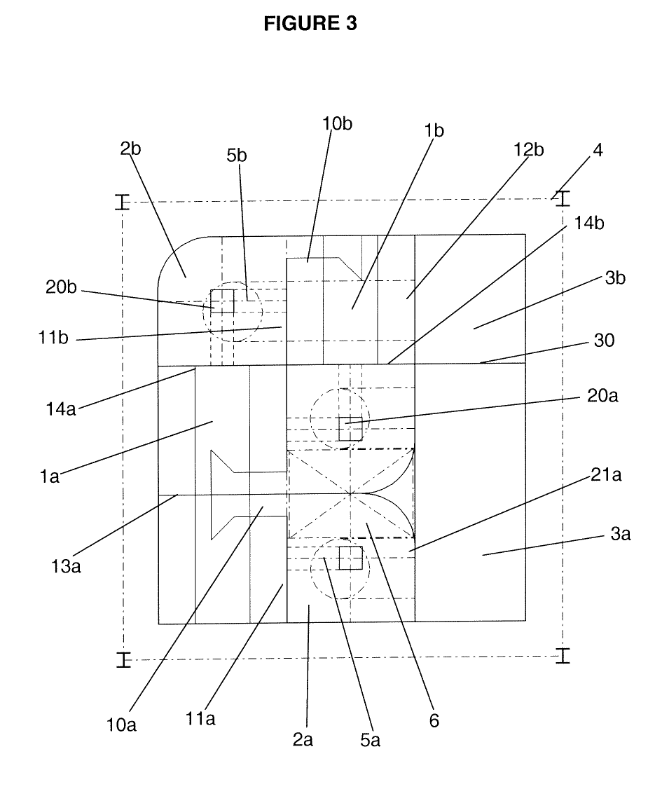

FIG. 3 is a top view of a combination of modules according to the invention

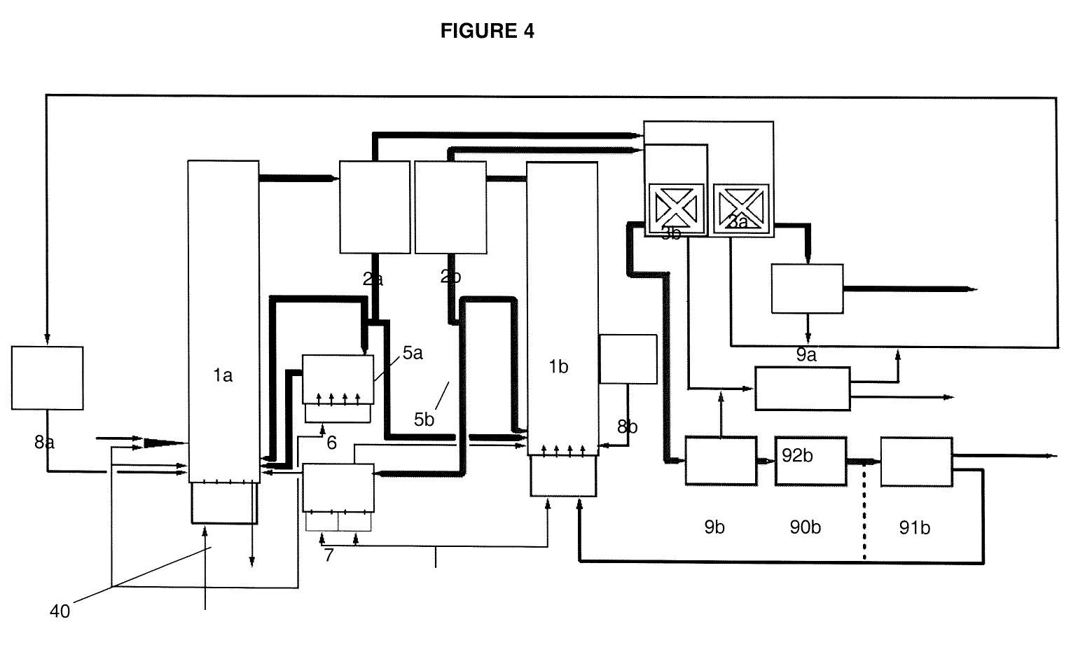

FIG. 4 is a schematic diagram of an installation, for installing the modules according to the invention

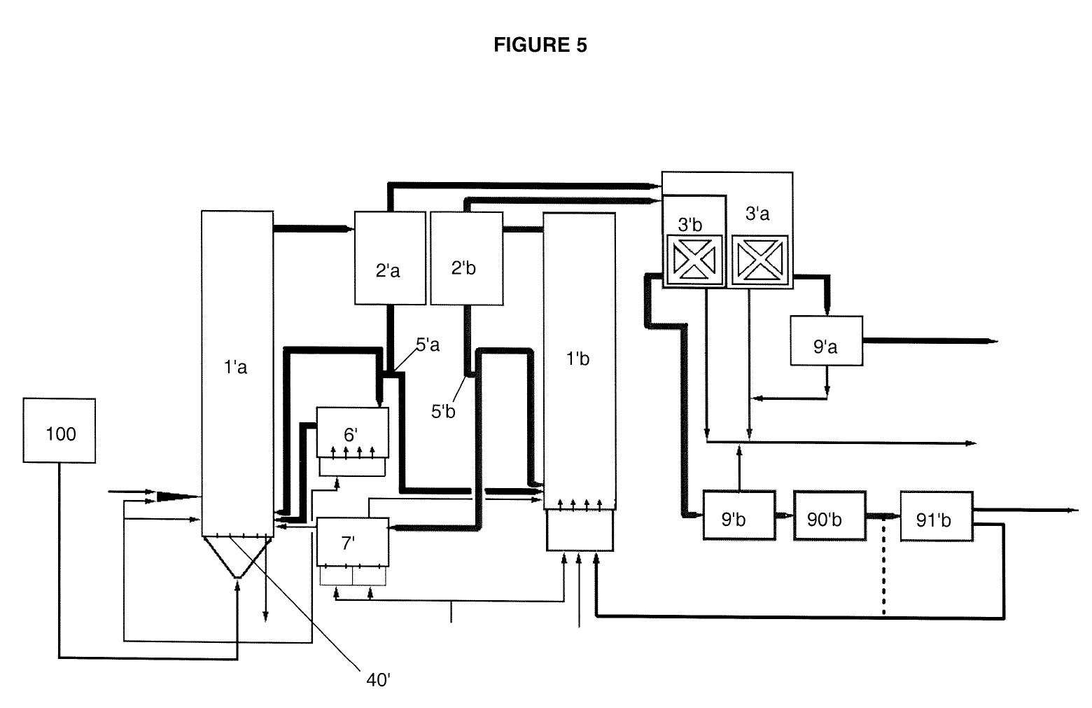

FIG. 5 is a schematic diagram of a second variant of the invention.

The module depicted in FIG. 1 comprises a reactor 1, a separator 2 located alongside and a rear cage 3, with the assembly being held together by metallic structures 4. This module corresponds to that described in patent application WO 2004/036118 of the applicant. Reactor 1 is connected to the separator by a sheath 10, which is partially or completely incorporated in said reactor 1. Reactor 1 has a common wall 11 with the separator 2 and a common wall 12 with the rear cage 3. Said walls are tubed with heat-conducting fluid running through them. The separator 2 has a solids outlet 20 connected to a siphon 5 that discharges to reactor 1. The fumes leave separator 2 and pass to the rear cage 3 by way of a sheath (not shown). The bottom of the hearth 1 comprises an area with a fluidisation grille 40.

The module depicted in FIG. 2 also comprises a reactor 1, a separator 2 and a rear cage 3. However, here, the reactor 1 is located at the centre between separator 2 and the rear cage 3. The separator 2 has a common wall 11 with reactor 1 and a common wall 21 with the rear cage 3. The solids—as shown in FIG. 1—pass via the outlet 20 before going through the siphon 5 and then returning to reactor 1. The fumes pass from the separator 2 to the rear cage 3 by a sheath (not shown). The bottom of the hearth 1 comprises an area with a fluidisation grille 40.

The combination of the two types of modules depicted in FIGS. 1 and 2 is particularly well suited to execute a double circulating fluidised bed boiler, which can be connected up to capture the CO₂. This particular embodiment is depicted in FIGS. 3 and 4.

FIG. 4 shows, in diagrammatic form, a double incorporated boiler comprising the following elements:
two circulating fluidised bed reactors 1a and 1b, of which one is an oxidation reactor 1a and the other a conversion reactor 1b, which are connected together for exchanging the oxygen-carrying solid metallic oxides, which are successively reduced before becoming oxidised in the two reactors 1a and 1b.
two separators, 2a and 2b
two siphons 5a and 5b respectively located under the separators 2a and 2b
an exterior bed 6 connected to the oxidation reactor 1a
a carbon sorting separator referred to as a carbon stripper 7, located on the solids return line from the conversion reactor 1b to the oxidation reactor
a.
two rear cages 3a and 3b
two silos 8a and 8b for the solid fuel
two filters 9a and 9b, a fan 90b, a cooling and condensation circuit 91b and an ash separator 92b.

The siphon 5a arranged under the separator 2a has three solid outlets—one for the direct return to the oxidation reactor 1a, one to supply the conversion reactor 1b with solids and one to supply the exterior bed 6 that controls the loop temperature, with solids.

The siphon 5b located under the separator 2b has two solid outlets, one for the direct return of the solids to the conversion reactor 1b and one to supply the oxidation reactor 1a with solids. It is also possible to dedicate each siphon to supplying one of the exterior beds or to supplying one of the conversion reactors.

FIG. 3 depicts the arrangement of the modules to execute the double boiler according to the invention. The double boiler comprises elementary modules, with said elementary modules being dimensioned so that one of the dimensions of the conversion reactor 1b—i.e. the width or length—is equal to the characteristic dimension—i.e. width or length—of separator 2a. The number of elementary modules to be used is calculated in relation to the power required for each reactor 1a and 1b. At least two, three or even four times more are required for the oxidation reactor 1a than for the conversion reactor 1b. This will provide the arrangement according to FIG. 3. The conversion reactor 1b is located between the separator 2b and the rear cage 3b. There is a common wall with one of the separators 2a, whilst separator 2b has a common wall with reactor 1a.

As can be seen from FIG. 3, the oxidation reactor 1a is made up of at least two identical modules and therefore comprises at least two identical cells. Its top section, roughly 10 m above the fluidisation grille 30, is divided up into sections by tubular walls 13a, where the tubes form an integral part of the inlet sheaths 10a of the separator 2a. The bottom section comprises one single part.

The conversion reactor 1b is reversed compared with the oxidation reactor 1a and its respective separators 2a and 2b are respectively juxtaposed by their common walls 11a and 11b with the reactors 1a and 1b and by the walls 14a and 14b with reactors 1a and 1b.

As can be seen from FIGS. 1, 2 and 3, the walls are virtually straight, meaning that it is possible to have common walls 11, 12, 13, 14a, 14b and 30 between the basic aligned modules. All these walls are tubed, meaning that it is possible to use thinner refractory linings of approx. 25 to 50 mm on the crown of the tube. The exothermal oxidation reactor 1a is protected by a thin refractory lining along the bottom section and in the sheath section 10a, as is also the separator 2a and siphon 5a. As for the endothermal conversion reactor 1b, its height is fully protected by a thin insulating refractory layer, as is also the sheath 10b, the separator 2b and siphon 5b.

The rear cages 3a are juxtaposed by walls 21a that are common to the separators 2a and by walls 30 common to the rear cage 3b. The rear cage 3b also has a wall 12b that is common to the conversion reactor 1b.

An exterior bed 6 that can be seen in FIGS. 3 and 4 is placed alongside the oxidation reactor 1a and is located under the separators 2a. It can also be arranged under the rear cage 3a. It is fed from siphon 5a. The use of the interior bed (not shown), tubed walls of the top divisions 13a and the internal exchangers (not shown) in the oxidation reactor 1a make it possible to minimise, where necessary, the size of the exterior bed and hence reduce its costs. In fact, internal fluidisation and the internal heat exchangers allow for the absorption of kilowatts.

We shall now briefly describe the operation of the unit with double reactor (oxidation and conversion).

The two, circulating fluidised bed reactors—the oxidation reactor 1a and the conversion reactor 1b—are connected together to allow for the exchange of oxygen-carrying, solid, metallic oxides, which are successively reduced and oxidated in the loop. The oxygen that is released in the conversion reactor 1b ensures combustion, without nitrogen, of the carbonated fuel introduced in said reactor 1b. The combustion products (CO₂, SO₂, H₂O) from the conversion reactor 1b, fluidised by recycled CO₂, SO₂, H₂O, are loaded as solids, which are separated in the separator 2b and re-introduced to the bottom of the reactor 1a via a siphon 5b. These combustion products are then cooled down again in a rear cage 3b, the dust is removed and they are then transferred to a CO₂ compression train for subsequent storage.

The reduced state solid, metallic oxides leaving the conversion reactor 1b are then transferred to the oxidation reactor 1a after undergoing a carbon stripping or carbon separation stage 7.

The oxidation reactor 1a is fluidised in air, which reacts with the oxides and conveys them to the top of the oxidation reactor 1a where the air, now deprived of oxygen, is loaded in solids, which then undergo separation in the separator 2a before being re-introduced to the base of the reactor 1a via a siphon 5a. This air, which is deprived of oxygen and CO₂ is cooled down in a rear cage 3a, where the dust is extracted and vented to atmosphere by a conventional flue.

Regarding the very large boilers of more than 200 MWe, it may be necessary, not only for reasons of thermal expansion of the assembly unit comprising reactors, separators and rear cages but also because of the excessive size of the belts maintaining the reactors at the internal pressure, to double certain walls, as shown in FIG. 3,—for example, wall 12b and walls 30, 14b and 14a. The overall arrangement is somewhat modified by this inter-wall spacing of approx. 800 mm.

As can be seen from FIG. 5, it is possible to use the invention to execute another type of CO₂ capturing process according to patent FR 2 814 533 of the applicant, which can be used at 650° C. approx. on a current of fumes from the boiler hearth 100. To simplify things, the same elements will be given the same references with a “prime” index

In such a case, the reactor 1′a is used as an absorber of the CO₂ contained in the fumes, of CaO lime that is carbonated by the absorption of CO₂ to replace the oxygen-carrying metallic oxides of the previous example. The solids extracted from reactor 1′a (CaO, CaCO₃, CaSO₄) are transferred to the reactor 1′b, in which the formed carbonates undergo cracking. The CO₂ released is likewise cooled, filtered and compressed. The CaO cracked in reactor 1′b is transferred to reactor 1′a for renewed CO₂ capture following cooling to 600° C. in bed 7′.

In a more detailed manner, the two circulating fluidised bed reactors—the absorption reactor 1′a and the cracking reactor 1′b—are connected together to ensure the exchange of calcium compounds acting as carbonate carriers and which are successively carbonated and cracked in the loop by raising the temperature to 900° C. in reactor 1′a through the injection of fuel and diluted oxygen into the CO₂. The combustion products (CO₂, SO₂, H₂O) from the conversion reactor 1′b, which are fluidised by a mixture of O₂ and recycled CO₂/SO₂/H₂O, are loaded as solids, which undergo separation in separator 2′b before being re-introduced to the bottom of the reactor 1′a via a siphon 5′b. These combustion products are then cooled down in a rear cage 3′b, de-dusted and transferred to a CO₂ compression train for subsequent storage.

The calcium compounds in the CaO state, leaving the conversion reactor 1′b, are then transferred to the absorption reactor 1′a after having undergone a cooling stage from 900° C. to 600° C. approx. in the cooling bed 7′.

The absorption reactor 1′a is fluidised by the fumes containing the CO₂ undergoing treatment, which reacts with the calcium compounds and which conveys them to the top of the absorption reactor 1′a. These fumes, with impoverished CO₂ content, are loaded as solids, which are separated in the separator 2′a and re-introduced to the bottom of reactor 1′a via a siphon 5′a. These fumes, which have an impoverished CO₂ content are cooled in a rear cage 3′a, de-dusted and rejected to atmosphere in a conventional flue.

1.-12. (canceled)

13. A circulating fluidized bed reactor comprising:
an assembly having at least a first module and a second module wherein said first module includes a first centrifugal separator (2, 2a) disposed between a first reaction chamber (1, 1a) and a first rear cage (3, 3a), and said second module includes a second reaction chamber (1, 1b) disposed between a second separator (2, 2b) and a second rear cage (3, 3b).

14. The circulating fluidized bed reactor according to claim 1, further comprising a first and second accelerator duct (10, 10a, 10b) disposed at least in part in the top of each respective first and second reaction chamber (1, 1a, 1b), and whereby the first and second centrifugal separators (2, 2a, 2b) include vertical walls that are substantially rectilinear.

15. The circulating fluidized bed reactor according to claim 14, wherein the vertical walls are in common.

16. The circulating fluidized bed reactor according to claim 1, wherein the first and second rear cages (3, 3a, 3b) of the first and second modules have a wall (30) in common.

17. The circulating fluidized bed reactor according to claim 1, wherein the first and second reaction chambers (1, 1a, 1b) and the first and second separators (2, 2a, 2b) have respective walls (11, 11a, 11b) in common.

18. The circulating fluidized bed reactor according to claim 1, wherein the second reaction chamber (1, 1b) and the second rear cage (3, 3b) have respective walls (12, 12b) in common.

19. The circulating fluidized bed reactor according to claim 1, wherein the first separator (2, 2a) and the first rear cage (3, 3a) have respective walls (21, 21a) in common.

20. The circulating fluidized bed reactor according to claim 1, wherein a wall (14a) in common between the first reaction chamber (1a) and the second separator (2b), a wall (14b) in common between the first separator (2a) and the second reaction chamber (1b), a wall (12b) in common between the second reaction chamber (1b) and the second rear cage (3b), and/or a wall (30) between the first and second rear cages (3a, 3b) are double walls and have stiffening belts in the space between the double walls.

21. The circulating fluidized bed reactor according to claim 1, wherein the at least one of the first and second modules constitutes an oxidation reactor and the other constitutes a conversion reactor.

22. The circulating fluidized bed reactor according to claim 21, wherein the oxidation reactor comprises at least twice as many modules as the conversion reactor.

23. The circulating fluidized bed reactor according to claim 22, wherein the conversion reactor includes the second module.

24. The circulating fluidized bed reactor according to claim 1, wherein at least one of the modules constitutes a first reactor for absorbing CO₂ contained in the fumes by carbonation of CaO, and the other constitutes a second reactor for cracking carbonates CaCO₃.
